(19) United States
(12) Patent Application Publication
(10) Pub. No.: US 2010/0263589 A1
(43) Pub. Date: Oct. 21, 2010

(54) DEVICE FOR SURFACE MASKING

(75) Inventors: Cynthia K. DEMPSTER, Decatur, AL (US); Mark D. Roberts, New Hope, AL (US); Larry W. Fullerton, New Hope, AL (US)

Correspondence Address: VENABLE LLP, P.O. BOX 34385, WASHINGTON, DC, 20043-9998, US

(73) Assignee: CEDAR RIDGE RESEARCH LLC, Huntsville, AL (US)

(21) Appl. No.: 12/427,101

(22) Filed: Apr. 21, 2009

(51) Int. Cl. B05C 11/00

(52) U.S. Cl. 118/505

(57) ABSTRACT

A masking panel to cover a protected first surface, such as a wall surface, floor surface, ceiling surface, door surface, door frame, fire place surface, window, window frame, window pane, decorative molding, chair rail or baseboard, while paint, stain, sealant or other chemicals is applied to an adjacent second surface. The masking panel includes a reusable protective material to be placed over at least a portion of the protected first surface. The reusable protective material includes at least one masking edge to create a masking boundary between the protected first surface and the adjacent second surface where the at least one masking edge has a masking edge shape that is pre-fabricated to substantially match the masking boundary. The masking panel additionally includes an adhesive fixed on the reusable protective material in the direction of the protected first surface along the at least one masking edge and at least one of the one or more holding edges to secure the reusable protective material to the protected first surface.

### BACKGROUND OF THE INVENTION

Conventional systems and methods for masking surfaces such as wall, glass, brick, or the like typically involve use of a masking tape, which is typically one to two inches wide but can be bought in wider sizes, for example, five to six inches wide. Typically, the user of masking tape must carefully unroll the tape while pressing it against a surface to be painted (or stained or otherwise have a chemical or other substance applied) in order to protect an adjacent surface. Much of what can be a time consuming effort can be spent attempting to achieve a straight edge between the surface to be painted and the surface being masked because the tape doesn't have sufficient rigidity to maintain a desired masking edge. Similar to masking tape, masking paper comes in a roll and therefore requires unrolling the paper and having to carefully hold the paper so that it doesn't coil while pressing it against the wall. Generally, masking tape and masking paper are very similar in that the nature of their packaging (being rolled) results in their having considerable flexibility that requires the user to use two hands to pull it sufficiently taunt to create a straight masking edge.

In a typical scenario, a user of a roll of masking tape unrolls and presses the tape to a wall surface immediately adjacent to a piece of molding, for example, door or window molding, crown molding, baseboard, chair rail, etc., so as to prevent paint being applied to the molding from getting onto the wall while also achieving a straight masking edge. Moreover, to protect a wider portion of the wall surface, a newspaper (or another protective material such as plastic, etc.) is often placed over the masking tape such that there is room to then add additional tape to hold it in place, perhaps using additional tape to hold an outer edge of the newspaper to the wall. Considerable time is usually required to apply (or install) the masking materials (tape, newspaper, etc.) and, after paint has been applied and dried, the masking materials are for the most part not usable for protection of another surface. As such, to paint a large number of rooms involving lots of moldings, a large amount of protective materials will typically be discarded.

In another typical scenario, considerable time is often spent placing masking tape around each window pane in a window before painting or staining the window. Again, often newspaper is placed over the portion of the panes not having masking tape and additional tape applied so as to fully cover the window panes. As with the previous scenario, considerable time and effort is required to install the masking materials, the installed masking materials are typically unusable for protecting additional surfaces, and a large quantity of masking materials are required to protect surfaces.

Therefore, there exists a need for an improved system and method for surface masking.

### SUMMARY OF THE INVENTION

Briefly, the present invention is a masking panel designed to cover a protected first surface, such as a wall surface, floor surface, ceiling surface, door surface, door frame, fire place surface, window, window frame, window pane, decorative molding, chair rail or baseboard, while paint, stain, sealant or other chemicals is applied to an adjacent second surface. The masking panel includes a reusable protective material to be placed over at least a portion of the protected first surface. The reusable protective material includes at least one masking edge to create a masking boundary between the protected first surface and the adjacent second surface, where the at least one masking edge has a masking edge shape that is pre-fabricated to substantially match the masking boundary.

The making panel also includes one or more holding edges. The masking panel additionally includes an adhesive fixed on the reusable protective material in the direction of the protected first surface along the at least one masking edge to secure the reusable protective material to the protected first surface.

The masking panels in an embodiment can be used to protect any surface, such as a wall, a brick surface, a ceiling, a floor, or the like, from paints, stains, sealants, or any other substance that can be applied to a surface. Moreover, the masking panels can be used to protect any desired surface, for example, a surface of a building, a surface of a boat, a surface of an airplane, a surface of a vehicle, or any other desired surface.

In an embodiment, the masking panels are made out of a protective material such as paper, plastic, or similar material sufficient for masking, and are pre-fabricated to have a desired masking area shape and a masking edge having a desired shape for installation against a corresponding surface having an edge shape corresponding to a masking boundary that is complementary to the desired masking edge shape. A desired masking edge shape can be a straight edge, a curved edge, or any other desired shape corresponding to the boundary between a surface to be masked (or protected) and a (non-protected) surface intended to have a substance, for example paint, applied to it. A desired masking edge shape may correspond to a measured masking edge shape, for example, a shape of a molding measured using a measurement tool such as a shaping template or contour gauge. Multiple protective materials can also be combined to produce a masking panel. The masking panels of the embodiment have a thickness that provides rigidity sufficient to maintain a desired masking edge shape during installation.

In another embodiment, the masking panel of the invention has a reusable pressure sensitive adhesive associated with the masking edge intended to bond (or adhere) the protective material to a surface being masked. As such, the adhesive is located between the protective material and the surface being masked. In an embodiment of the invention, the adhesive associated with the masking edge is located along the masking edge so as to prevent any leakage of paint onto the surface being masked. Adhesive may be located at one or more other locations on a masking panel, such as other edges, corners, locations within the inner portions of the panel, or any other desired location that might be appropriate to hold the masking panel in place after installation.

One or more different adhesives can be used with the invention, where the one or more different adhesives may vary in the extent to which they cause a masking panel, or portion of a masking panel, to bond to a surface, or a portion of a surface, being protected. For example, an adhesive(s) used with a masking panel intended to protect a sheet rock wall surface might be different from an adhesive(s) used to adhere a masking panel to a brick surface. Generally, the bonding characteristics of a given adhesive used in accordance with the present invention can be tailored to meet specific requirements of the surface being masked.

In another embodiment, a magnetic strip can be used in place of a reusable pressure sensitive adhesive to adhere a masking panel to a metal surface.

In a further embodiment, the masking panels of the present invention consist of rectangular sheets of heavy duty paper, each having at least one masking edge and having sufficient rigidity to maintain the masking edge during installation. Under one embodiment, such panels have a relatively strong adhesive along a side providing a sufficiently rigid straight masking edge and weaker adhesive on sides other than the side providing the masking edge.

In an embodiment, the panels are packaged in a stack such that the adhesives are also used to attach masking panels to each other in addition to adhering to masked surfaces.

With one approach, the panels are packaged in a stack whereby adhesive is on alternating edges of each successive panel such that successive panels have masking edges oriented 180° relative to each other. With this approach, the thickness of the stack remains substantially unbiased from one side to the other. With another approach, the panels are packaged in a stack whereby masking edges and corresponding adhesive layers are stacked on top of each other.

In another embodiment, one or more portions of adhesives have a removable strip that must be removed to expose the adhesive prior to installation.

In a further embodiment, a long masking panel has perforations thereby allowing individual paint panels of desired lengths to be produced by separating perforations. In a similar arrangement, long masking panels have folds enabling their length to be reduced while packaged. These two approaches can be combined such that panel portions can be folded at perforation lines allowing individual portions to be used separately, or allowing two or more panel portions to be unfolded and used together without tearing the perforation lines between the panel portions. Alternatively, a long masking panel can be folded and then later unfolded and torn or cut to achieve a desired length.

In an embodiment, masking panels are designed such that a portion of a panel along the masking edge has a lesser thickness than the remainder of the panel providing a region for a strip covering an adhesive such that the thickness of that portion, the adhesive, and the covering strip have a total thickness that substantially equals the remainder of the panel. This arrangement enables packaging where the stack of panels is not biased towards one side. Moreover, the thicker portion of the panel not having the covered adhesive provides additional control to the user due to its additional rigidness. Under a similar arrangement, a masking tape can be attached along an edge of a more rigid protective material such that a portion of the tape is able to be used for achieving a masking seal.

In an embodiment, a masking panel has adhesive on at least one side of its top surface and adhesive on at least one opposing side its bottom surface. The adhesive on the bottom surface is used to provide a masking edge along a surface to be painted. The adhesive on the top surface is used to provide an attachment edge for attaching the masking panel to additional protective material in order to extend masking area coverage. After the masking panel has been installed alongside a surface to be painted, a second masking material, such as plastic sheeting, can then be attached to the adhesive on the top surface of the masking panel so as to extend the masking surface area, for example to protect an entire floor.

In a further embodiment, the masking panel can optionally include an anti-wetting coating applied to a masking edge. Under one arrangement an anti-wetting coating comprises a Teflon coating. Under another arrangement an anti-wetting coating comprises a wax coating.

### BRIEF DESCRIPTION OF THE DRAWINGS

The present invention is described with reference to the accompanying drawings. In the drawings, like reference numbers indicate identical or functionally similar elements.

Additionally, the left-most digit(s) of a reference number identifies the drawing in which the reference number first appears.

FIG. 1A depicts an exemplary masking panel in accordance with the invention;

FIG. 1B depicts a second exemplary masking panel in accordance with the invention;

FIG. 1C depicts a third exemplary masking panel in accordance with the invention;

FIG. 1D depicts a fourth exemplary masking panel in accordance with the invention;

FIG. 1E depicts a fifth exemplary masking panel in accordance with the invention;

FIG. 1F depicts a sixth exemplary masking panel in accordance with the invention;

FIGS. 2A-2C depict an exemplary masking panel having different thicknesses and a removable strip covering an adhesive in accordance with an embodiment of the invention;

FIG. 3A depicts an exemplary masking panel having perforations;

FIG. 3B depicts an exemplary masking panel having folds;

FIG. 3C depicts stacked masking panels having adhesives on alternating sides;

FIGS. 4A and 4B depict a front view and a side view of an chimney and fireplace and exemplary use of masking panels around a mantel of the fireplace, respectively;

FIG. 5 depicts exemplary masking of various surfaces using the masking panels of the invention;

FIG. 6A depicts exemplary masking of window panes using masking panels of the invention;

FIG. 6B depicts exemplary masking of a wall surface next to a curved window frame;

FIG. 7A depicts a seventh exemplary embodiment of the masking panel in accordance with the invention; and

FIGS. 7B and 7C depict exemplary usage of the masking panel of FIG. 7A.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art. Like numbers refer to like elements throughout.

The present invention provides an improved system and method for surface masking involving a masking panel having at least one masking edge pre-fabricated to have a masking shape that substantially matches a desired masking boundary between a non-protected surface intended to have a substance (e.g., paint) applied to it and an adjacent protected surface intended to be masked so the substance will not be applied to it. The masking panel has sufficient rigidity to maintain the masking edge shape during installation along the making boundary. The panels have a pressure sensitive adhesive enabling them to be easily attached to a protected surface and also to be easily removed and reinstalled against a similar surface. The masking panels of the present invention can be used to protect any surface associated with a building, such as a wall, fire place bricks, window glass, a ceiling, a floor, or the like, from paint, stains, sealants, or any other substance that one might want to apply to a surface. Moreover, the masking panels of the present invention can be used to protect other desired surfaces, for example, a surface on a boat, a surface on an airplane, a surface on a vehicle, or any other desired surface where a masking panel having a desired masking edge shape meeting masking requirements, for example a straight masking edge, a curved masking edge, or a masking edge having a masking edge of any other desired shape can be used. A masking edge shape may correspond to a measured masking edge shape such as the shape of a molding measured with a measurement tool such as a contour gauge or shaping template. Masking panels can also have multiple masking edges.

In accordance with the present invention, masking panels having a desired masking area shape are made out of paper, plastic, or similar material sufficient for masking and have at least one masking edge pre-fabricated to have a desired masking shape for installation against a corresponding surface to create a masking boundary having shape characteristics complementary to (i.e., substantially matching) the desired masking edge shape. For example, many surfaces that are painted in a home, for example a window frame, have a straight edge next to a surface to be masked, for example a wall surface, where a masking panel that provides a straight masking edge is desirable since it can be easily placed alongside the straight edge of the window frame and adhered to the wall surface for masking purposes. Other shapes for masking panels can be used in accordance with the invention as appropriate to provide other desired masking edge shapes, for example, a masking edge with a desired curvature. The masking panels of the invention are also referred to herein as paint panels, protective panels, or panels. They are also referred to by the inventors as Mask-it™ panels.

The masking panel of the invention has a thickness that provides rigidity sufficient to provide and maintain a desired masking edge shape during installation. In other words, the rigidity of the panel itself provides and maintains the masking edge without requiring any force to be applied to the panel to create the masking edge, such as having to use two hands to pull masking tape or paper taunt so as to create a straight masking edge. Such sufficient rigidity can be understood by comparing the rigidity of a piece of poster board to the rigidity of a piece of notebook paper. With a piece of poster board oriented vertically such as would be typically required to mask a vertical wall, one can hold the bottom corner of the right side of the poster board and the edge of the left side will remain substantially straight such that one could easily place the left side of the poster board alongside the straight edge of a window frame. However, should one similarly hold the right bottom corner of a piece of notebook paper oriented vertically, its lack of sufficient rigidity will cause it to fold over or coil about the holding point such that it cannot be easily placed alongside the straight edge of a window frame. This same sufficient rigidity test can be used with a piece of masking tape or masking paper, which will tend to coil due to the thinness and lack of rigidity of the tape or paper. The thickness and therefore rigidity of masking tape and masking paper, in contrast to the masking panel of the present invention, are specifically selected to enable the tape or paper to be packaged and dispensed in rolls. The masking panels of the present invention have thickness and rigidity making them unsuitable for being packaged and dispensed in a roll but instead more suited to being stacked or folded on top of one another. For both cost and aesthetic reasons, it is generally desirable to achieve such sufficient rigidity with as thin a protective material as possible while also ensuring the material is able to prevent leakage through it.

The masking panel of the invention has a reusable pressure sensitive adhesive, for example an adhesive comparable to that adhesive used with masking tape, associated with the masking edge. In a preferred embodiment of the invention, the adhesive associated with the masking edge is located along the masking edge so as to provide a masking seal that prevents leakage of any paint beneath the installed masking panel onto the surface being masked. Masking panels may also include additional adhesive at one or more other locations, such as other edges, corners, locations within the inner portions of the panels, or any other desired location that might be appropriate to hold the masking materials in place after being installed. Adhesive locations, as with the shape of the masking panel, may be tailored based on the specific characteristics of the surfaces being painted and masked, which is referred to herein as the masking scenario. In a manner similar to determining the appropriate thickness to achieve sufficient rigidity and ability to protect a surface, the bonding ability of the adhesive would typically be a tradeoff between the characteristics of an adhesive required to achieve a bond that will hold the masking panel in place and achieve a seal along the masking edge sufficient to prevent leakage, while at the same time being easy to remove and not damaging the masked surface, such as removing paint from the protected surface. Moreover it is desirable that all adhesive remain on the panel when it is removed from a surface. As referred to herein, a relatively strong adhesive, such as is used with common masking tapes and masking papers, provides a seal sufficient to prevent leakage and a bond that will hold the masking panel in place while a relatively weaker adhesive, such as is used with Post-it® notes, provides a bond that will hold the masking panel but may or may not provide a sufficient seal to prevent leakage.

Typically, a user of a masking panel would hold the panel by a holding edge opposite the masking edge when installing it alongside the edge of the surface being painted and then use the other hand to press the panel against the surface being masked so as to bond the adhesive to that surface and achieve a seal along the masking edge to prevent leakage of paint (or some other substance) onto the masked surface. One or more different adhesives can be used with the invention, where the one or more different adhesives may vary in the extent to which they cause a protective panel, or portion of a protective panel, to adhere to a surface, or a portion of a surface, being protected. For example, an adhesive(s) used with a masking panel intended to protect a sheet rock wall surface might be different from an adhesive(s) used to adhere a paint panel to a brick surface.

Generally, the extent to which a given adhesive bonds to a given surface can be designed to meet bonding requirements of a surface to be masked, as appropriate. Moreover, a magnetic strip can be used in place of an adhesive to enable a masking panel to adhere to a metal surface.

Under one arrangement, the masking panels of the present invention consist of rectangular sheets of paper having at least one masking edge and having sufficient rigidity to enable a user to hold the panel so as to place a straight edge up against a surface to be painted, for example molding around a door, and press the panel where adhesive is present to adhere the panel to a surface being masked, such as a wall surface surrounding the door molding. Under one arrangement, such panels have one relatively light (easily removed) adhesive on sides of the panel not providing a masking edge, and relatively heavier adhesive along a side providing a masking edge.

Under another arrangement, an anti-wetting coating is applied to a masking edge to shed paint. An anti-wetting coating may comprise a Teflon coating or a wax coating.

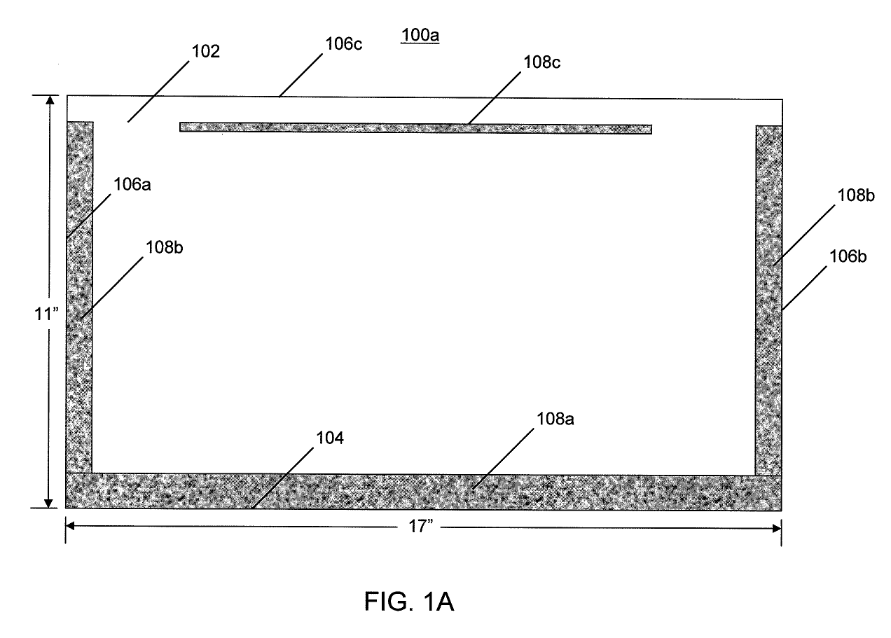

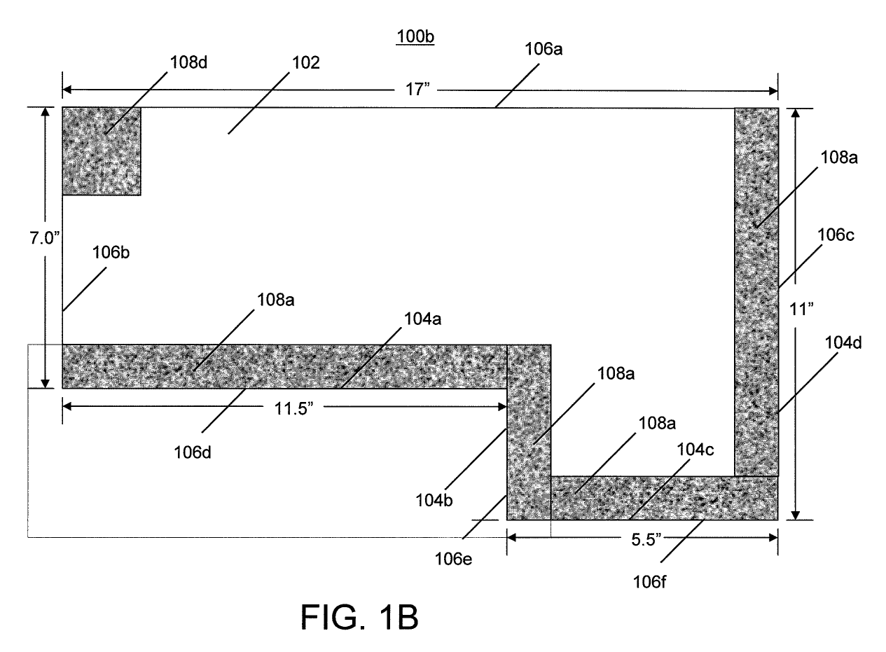

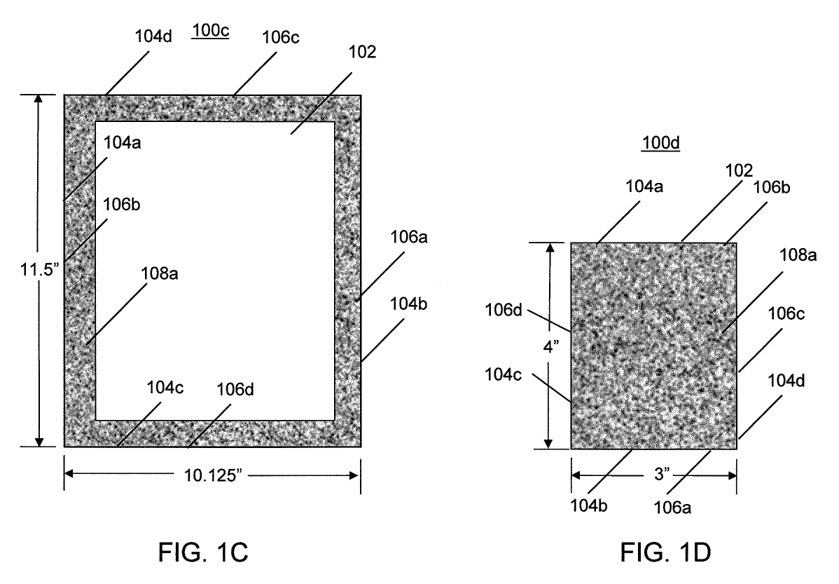

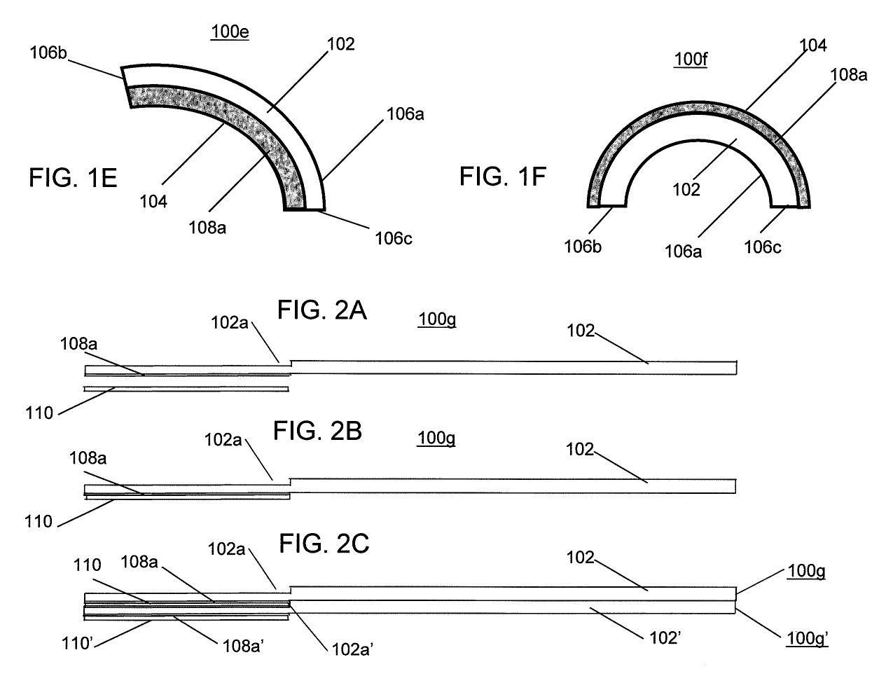

FIG. 1A depicts an exemplary masking panel in accordance with the invention. Referring to FIG. 1A, an exemplary masking panel 100a comprises an 11 inch×17 inch piece of protective material 102, for example construction paper, having a straight masking edge 104 and three holding edges 106a, 106b, 106c. A row of relatively heavy (strong bonding) adhesive 108a approximately one inch wide is alongside the masking edge 104 enabling a masking seal. Alongside the holding edges 106a, 106b along both of its 11 inch wide sides are three quarter inch wide rows of a relatively lighter (weaker bonding) adhesive 108b. The masking edge 104 of masking panel 100a can easily be placed against a corresponding straight edge of a door frame, a window frame, a baseboard, a decorative molding, or any other surface having such a straight edge while holding the panel with one hand by one of the holding edges 106a, 106b, 106c and applying pressure with the other hand to the adhesive along the masking edge 104 so as to achieve a masking seal. FIG. 1A also depicts a very thin row of adhesive 108c placed near but offset from the holding edge 106a opposite the masking edge 104. As depicted, there is a portion of the panel 100a alongside the outside holding edge 106c that does not have any adhesive thereby enabling someone to lift that portion easily when removing the panel from a protected surface. Generally, a rectangular shaped masking panel 100a can have any desired width and length, one or more sides can be masking edges, and/or one or more sides can be holding edges.

Throughout this specification, and particularly in the drawings, areas of masking panels having adhesives are represented by a darkened pattern. One skilled in the art will recognize that when the masking panels are used that the adhesive would be between the protective material and the masked surface (e.g., a wall) and as such the adhesive may not be visible when looking at the masking panel from the side not having the adhesive. As such, in accordance with one embodiment of the invention, markings can be placed on the side of the protective material opposite the side having an adhesive in such a manner as to indicate where adhesive is present on the other side. Different colors or markings may also indicate adhesives intended for a masking edge versus other adhesives intended for bonding purposes only. Where drawings depict usage of masking panels having darkened patterns, those darkened panel should be interpreted as indicating locations of adhesive between the protective material and the masked surface and indicating optional markings indicating adhesive locations. Anti-wetting coatings would coincide with the outermost edge of the darkened patterns corresponding to masking edges.

FIG. 1B depicts a second exemplary masking panel in accordance with the invention. Referring to FIG. 1B, an exemplary masking panel 100b has four masking edges 104a, 104b, 104c, 104d that can be fitted around a corner, for example a corner of a door frame or a window frame, or within a corner, for example where two pieces of molding join at a corner of a wall. Referring to FIG. 1B, masking panel 100b comprises a protective material 102, for example a clear plastic material, having four masking edges 104a, 104b, 104c, 104d each having a strong adhesive 108a enabling a masking seal. Two of the masking edges 104a, 104b can be fitted around an outside corner and two other masking edged 104c, 104d can be fitted within an inside corner. FIG. 1B also depicts adhesive 108d placed in a corner of the masking panel 100b that is provided for attachment to the protected surface. Because of the design of the masking panel 100b, any one of its six sides 106a, 106b, 106c, 106d, 106e, 106f can be used as a holding edge depending on how the panel is used. The lengths of the masking panel sides depicted in FIG. 1B were arbitrarily selected and can be of any desired length. Moreover, many different configurations are possible to produce masking panels capable of fitting around corners, fitting within corners, or both to include fitting around or within multiple corners.

FIG. 1C depicts a third exemplary masking panel in accordance with the invention. Referring to FIG. 1C, a masking panel 100c is sized to mask a window pane. More specifically, the outer dimensions of masking panel 100c are sized to match the outer dimensions of the window pane thereby providing masking to the window pane when painting the wooden portions about the window panes. Masking panel 100c comprises a protective material 102 having four masking edges 104a, 104b, 104c, 104d and four holding edges 106a, 106b, 106c, 106d. A band of a relatively strong adhesive 108a is shown in a band about the perimeter of the panel thereby enabling a masking seal completely around the panel.

FIG. 1D depicts a fourth exemplary masking panel in accordance with the invention.

Referring to FIG. 1D, a masking panel 100d can be sized in many of various sizes to include the size of a window pane. Like masking panel 100c, masking panel 100d has four masking edges 104a, 104b, 104c, 104d and four holding edges 106a, 106b, 106c, 106d. As depicted, an adhesive 108a is provided across the entire masking panel 100d, which may be desired for certain applications. Generally, a masking panel 100d can be used to fill in gaps and protect small areas that require masking, where a user can hold the panel by any side and one or more of the sides can be used as masking edges.

FIG. 1E depicts a fifth exemplary masking panel in accordance with the invention. Referring to FIG. 1E, a masking panel 100e consists of a protective material 102 having a curved shape resembling an arch. As depicted, an innermost edge of the protective material 102 is a masking edge 104 having a band of relatively strong adhesive 108a. The remaining sides of the protective material 102 can be holding edges 106a, 106b, 106c.

FIG. 1F depicts a sixth exemplary masking panel in accordance with the invention.

Referring to FIG. 1F, a masking panel 100f consists of a protective material 102 having a curved shape resembling half of a 180° arch. As depicted, an outermost edge of the protective material 102 is a masking edge 104 having a band of relatively strong adhesive 108a. The remaining sides of the protective material 102 can be holding edges 106a, 106b, 106c.

FIGS. 2A-2C depict an exemplary masking panel having different thicknesses and a removable strip covering an adhesive in accordance with an embodiment of the invention. Referring to FIG. 2A, a masking panel 100g comprises a protective material 102 having a first thickness and a second thickness that is less thick than the first thickness. An adhesive 108a is placed on the bottom side of the protective material 102 with a width less than or equal to the width of the portion of the protective material 102 having the second thickness. A removable strip 110 is placed over the adhesive 108a. As shown, the difference in thicknesses of the two portions of the protective material 102 provide a recessed region 102a where the adhesive 108a and removable strip 110 from a first masking panel 100g can reside stacked on top of the recessed portion 102a′ of a second masking panel 100g′. As such, multiple masking panels 100g having adhesive 108a and a removable strip 110 on just one side of each masking panel 100g can be stacked and the stack will maintain relatively straight up and down.

Generally, one or more protective materials can be used to produce a masking panel and any such protective material(s) can have one or more thicknesses as desired for a given application. For example, a masking tape can be attached along an edge of a more rigid protective material such that a portion of the tape is able to be used for achieving a masking seal while the protective material has sufficient rigidity to maintain a masking edge during installation. However, with this approach, it is best that the masking tape have sufficient rigidity so as to not bend during installation.

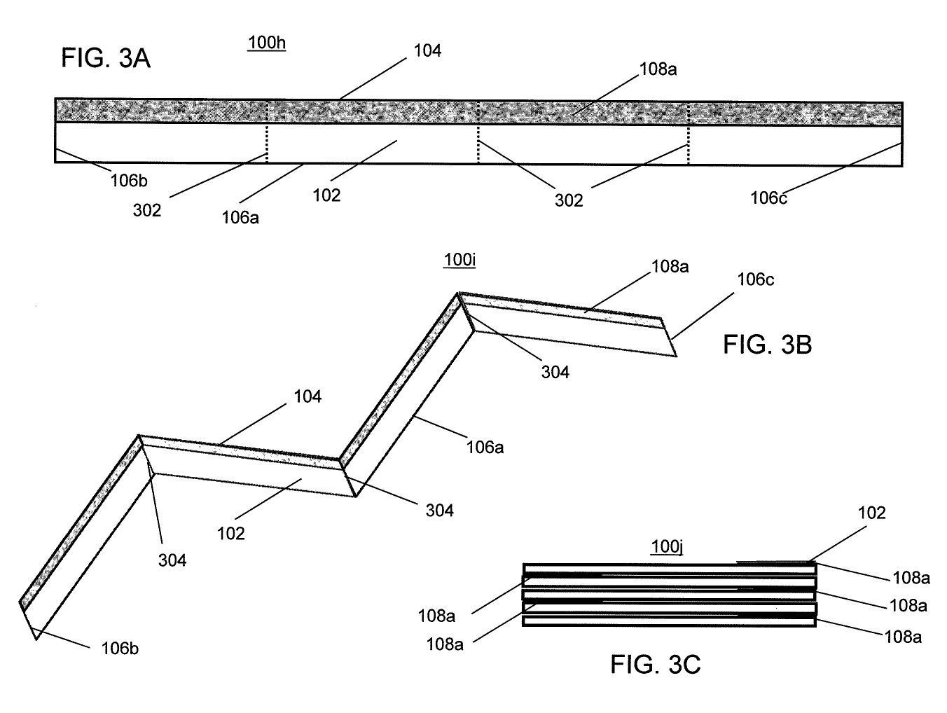

FIG. 3A depicts an exemplary masking panel having perforations. Referring to FIG. 3A, an exemplary masking panel 100h comprises a protective material 102 having a rectangular shape with a much longer length than width, for example a length of four feet and a width of four inches. Masking panel 100h has a masking edge 104 with adhesive 108a along the top edge and has three holding edges 106a, 106b, 106c. Also depicted in FIG. 3A are perforations 302 that can be used to separate the masking panel 100h into two to four portions, for example four one foot by four inch masking panels. The embodiment of a masking panel 100h is suited for long straight edges such as those of baseboards, crown molding, the sides of door frames, etc.

FIG. 3B depicts an exemplary masking panel having folds. Referring to FIG. 3B, an exemplary masking panel 100i comprises a protective material 102 having a rectangular shape with a much longer length than width, for example a length of four feet and a width of four inches. Masking panel 100i has a masking edge 104 with adhesive 108a along the top edge and has three holding edges 106a, 106b, 106c. Also depicted in FIG. 3B are folds 304 that can be used to reduce the length of the masking panel for packaging purposes. The embodiment of a masking panel 100i is also suited for long straight edges such as those of baseboards, crown molding, the sides of door frames, etc. Alternatively, a masking panel may have both folds and perforations.

FIG. 3C depicts stacked masking panels having adhesives on alternating sides. Referring to FIG. 3C, an exemplary stack of five masking panels 100j each comprising a protective material 102 and having adhesive 108a along one side which alternates with successive panels in the stack. This approach can be used to keep a stack generally straight up and down even though adhesive is on only one side of each panel. Alternatively, panels having adhesive on opposing sides can be stacked one on top of the other and will stack generally straight up and down.

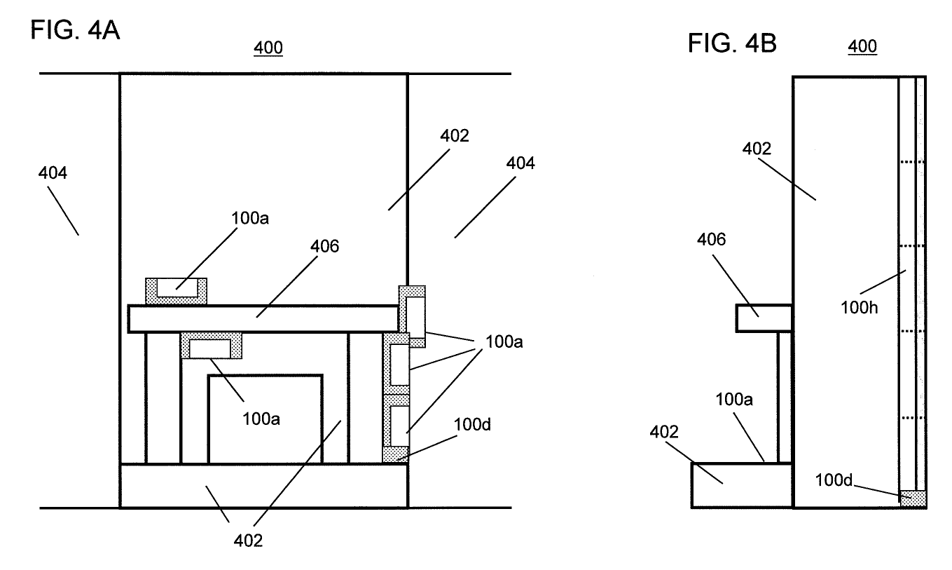

FIGS. 4A and 4B depict a front view and a side view of a chimney and fireplace, and exemplary use of masking panels around a mantel of the fireplace that is to be painted and on brick alongside nearby walls to be painted, respectively. Referring to FIGS. 4A and 4B, a masking scenario 400 involves a brick chimney 402, walls 404, and a fireplace mantel 406. As shown in FIG. 4A, masking panels 100a placed alongside mantel 406 can be used to protect nearby brick from paint. Where necessary, smaller masking panels 100d can be used to fill in gaps. As shown in FIG. 4B, a long masking panel 100h can be placed on brick alongside a wall to be painted. As necessary, smaller masking panels 100d can be used to fill in gaps. FIG. 4B also depicts use of a masking panel 100a to protect bricks next to a bottom portion of the mantel 406.

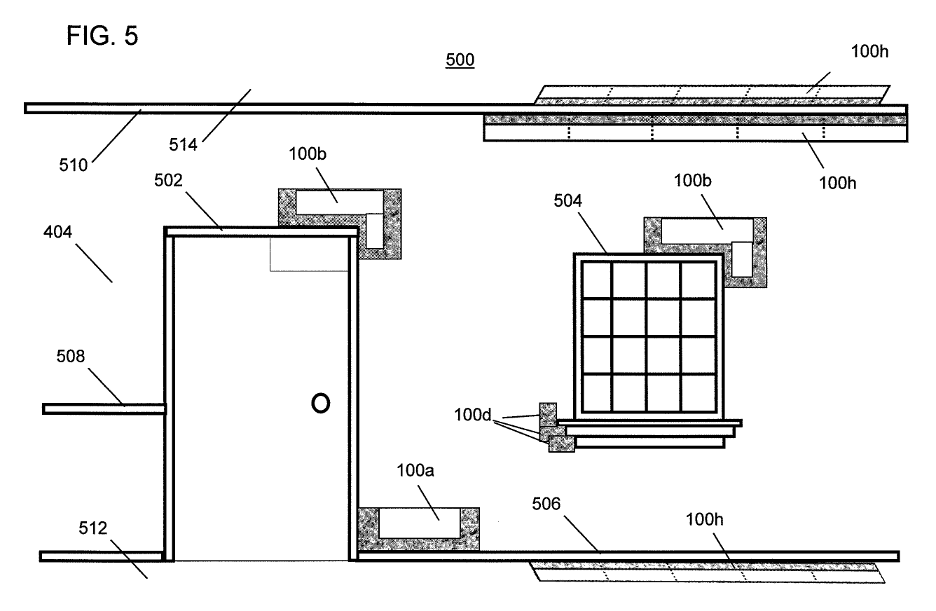

FIG. 5 depicts exemplary masking of various surfaces using the masking panels of the invention. Referring to FIG. 5, a typical room has various surfaces that may need masking during painting. In the painting scenario 500 shown in FIG. 5, a doorframe 502, window frame 504, baseboard 506, chair rail 508, and crown molding 510 are to be painted while protecting a wall 404, floor 512, and ceiling 514 from the paint applied to the other surfaces. A masking panel 100a is shown protecting the wall 404 near an inside corner resulting from the adjoining doorframe 502 and baseboard 506. Masking panels 100b are shown protecting the wall 404 near outside corners of the doorframe and window frames, and masking panels 100d are shown covering smaller areas about the bottom of the window frame. Additionally, additional masking panels 100h are shown protecting the wall 404 and ceiling 514 alongside the crown molding 510 and protecting the floor 512 alongside baseboard 506.

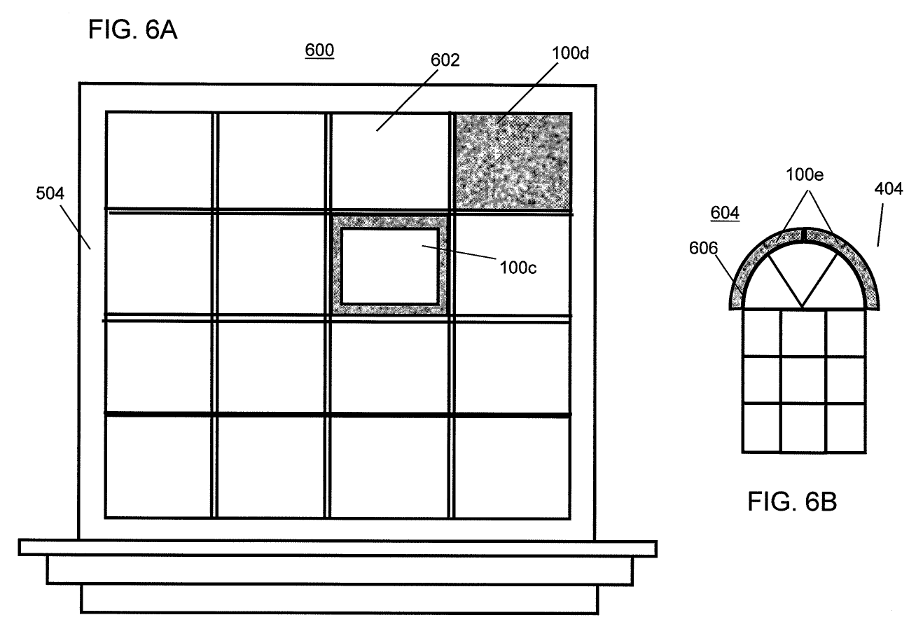

FIG. 6A depicts exemplary masking of window panes using masking panels of the invention. Referring to FIG. 6A, a painting scenario 600 involves a window frame 504 to be painted where it is desirable to not paint window panes 602. As depicted, two of the window panes are shown being masked by paint panels 100c, 100d.

FIG. 6B depicts exemplary masking of a wall surface next to a curved window frame.

Referring to FIG. 6B, a painting scenario 604 involves a curved window frame 606. As shown, curved masking panels 100e are used alongside the curved window frame 606 to mask an adjoining wall surface 404.

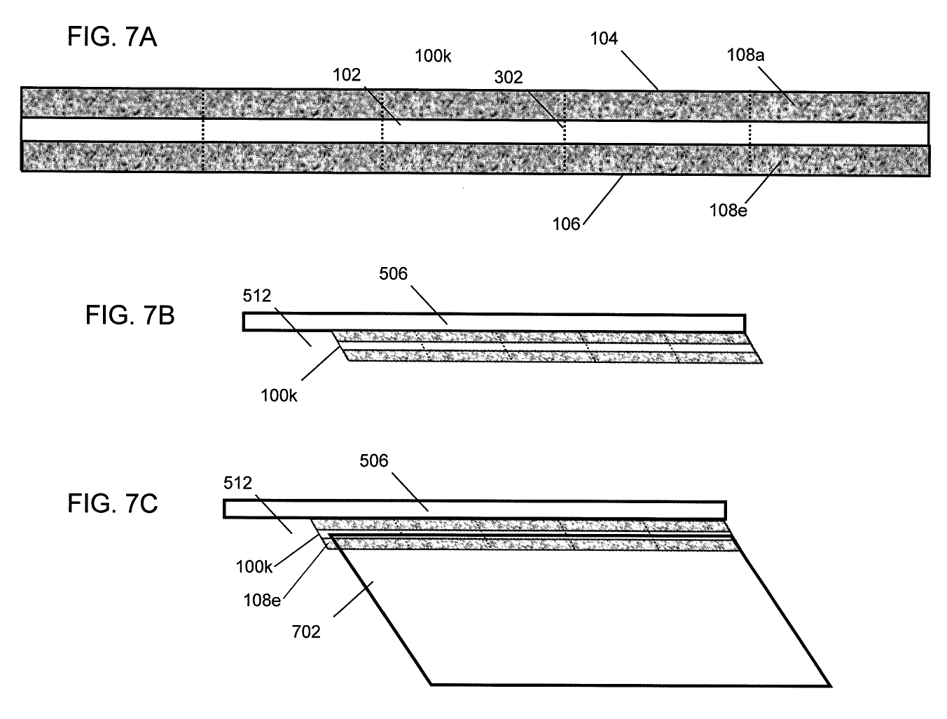

FIG. 7A depicts a seventh exemplary embodiment of the masking panel in accordance with the invention. Referring to FIG. 7A, a masking panel 100k comprises a protective material having a straight masking edge 104 and a holding edge 106 opposite the masking edge 104. The masking panel 100k is also shown having perforations 302. Masking panels could optionally include folds 304. On the bottom of the masking panel a strong adhesive 108a is provided alongside the masking edge 104 to enable a masking seal. On the top of the masking panel alongside the holding edge 106 is additional adhesive 108e that can be used to attach additional protective material to the masking panel in order to provide greater masking area coverage.

FIGS. 7B and 7C depict exemplary usage of the masking panel of FIG. 7A. Referring to FIG. 7B, the masking panel 100k is placed on a floor 512 alongside a baseboard 506 in order to protect the floor. In FIG. 7C, additional protective material, for example plastic sheeting or newspaper, is adhered to the additional adhesive 108e of the masking panel 100k. The combination of the masking panel 100k and the additional protective covering 702 can be moved to protect other areas (e.g., other floors) and once painting is completed, the additional protective material 702 can be detached from the masking panel 100k for reuse.

One skilled in the art will recognize that various techniques can be used to provide rigidity to a masking edge in accordance with the present invention to include providing a reinforcing material, for example a metal wire or metal strip, within the protective material making up the masking panel. The thickness of a masking panel may vary from one side to another, for example in a shape somewhat resembling a wedge. Adhesives can be applied to masking panels during manufacturing or prior to use. For example, a two-sided masking tape could be applied alongside an edge of a protective material to produce a masking edge and could similarly be applied to the other side of a masking panel to attach additional protective material.

Based on the forgoing, a masking panel is fully described that has at least one masking edge that are pre-fabricated to have a masking shape that substantially matches a masking boundary between a protected surface and a non-protected surface where a substance, such as paint, stain, sealant or oil, is to be applied on the non-protected surface. As such, the masking panel creates the desired masking boundary when installed on a surface to be protected that is adjacent to the surface on which the substance is applied. The masking boundary can be a straight line or a curved line or some combination. The masking boundary can also comprise two straight lines that are perpendicular to each other. A protective material has at least one masking edge having a masking edge shape that is pre-fabricated to substantially match a masking boundary. The protective material, such as paper, cardboard, plastic or rubber, has sufficient rigidity to maintain the masking edge shape between a protected surface and an unprotected surface adjacent to the protected surface during installation of the masking panel. The protected surface can be a wall surface, a brick surface, a ceiling surface, a floor surface, a surface of a building, a glass surface, a surface of a boat, a surface of an airplane, or a surface of a vehicle. The protective material can be sized to fit a window pane or around a molding. An adhesive layer is positioned on one side of the protective material in sufficient quantity at an orientation that holds the masking edge against the protected surface at a desired position relative to the unprotected surface so as to prevent the substance that is being applied to the unprotected surface from being applied to the protected surface. The adhesive layer can have opposing adhesive sides and a removable strip can also be place on the adhesive layer.

According to some of the more detailed of the present invention, the adhesive layer comprises a pressure sensitive adhesive being adhered to the protected surface by pressure applied during the installation of the masking panel by a first hand while a second hand holds a non-adhesive holding edge. A masking edge can be a straight edge, an outside corner edge, an inside corner edge, a curved edge, or a measured edge or a plurality of masking edges that are perpendicular to each other.

According to other more detailed of the present invention, the making panel can include at least one fold or performation. Another adhesive layer may be positioned on an opposing side of the one side of the protective material in sufficient quantity at an orientation to attach an extension protective material to the protective material. A removable strip covering the other adhesive layer enables the extension protective material to be attached to the masking panel. The protective material can be different form the extension protective material, for example, a non-rigid material.

While particular embodiments of the invention have been described, it will be understood, however, that the invention is not limited thereto, since modifications may be made by those skilled in the art, particularly in light of the foregoing teachings.

What is claimed is:

1. A masking panel that creates a masking boundary between a protected surface and an unprotected surface adjacent to said protected surface, comprising:
a protective material having at least one masking edge, said at least one masking edge having a masking edge shape corresponding to said masking boundary, said masking edge shape being pre-fabricated to substantially match said masking boundary; and
an adhesive layer positioned on one side of the protective material in sufficient quantity at an orientation that holds the masking panel against the protected surface along said masking boundary and provides a masking seal that substantially prevents the substance that is being applied to the unprotected surface from being applied to the protected surface.

2. The masking panel of claim 1, wherein said adhesive layer comprises a pressure sensitive adhesive being adhered to said protected surface by pressure applied during the installation of said masking panel by a first hand while a second hand holds a holding edge.

3. The masking panel of claim 1, wherein said masking boundary comprises at least one of a straight line or a curved line.

4. The masking panel of claim 3, wherein said masking boundary comprises two straight lines that are perpendicular to each other.

5. The masking panel of claim 1, wherein said at least one masking edge comprises at least one of a straight edge, an outside corner edge, an inside corner edge, a curved edge, or a measured edge.

6. The masking panel of claim 1, wherein said at least one masking edge comprises a plurality of masking edges that are perpendicular to each other.

7. The masking panel of claim 1, wherein said protective material is sized to fit at least one of a window pane or around a molding.

8. The masking panel of claim 1, further comprising a removable strip on said adhesive layer.

9. The masking panel of claim 1, wherein said masking panel includes at least one of a fold or a perforation.

10. The masking panel of claim 1, wherein said adhesive layer has opposing adhesive sides.

11. The masking panel of claim 1, wherein said protective material comprises at least one of paper, cardboard, plastic or rubber.

12. The masking panel of claim 1, wherein said protected surface comprises at least one of a wall surface, brick surface, ceiling surface, floor surface, surface of a building, a glass surface, surface of a boat, surface of an airplane or surface of a vehicle.

13. The masking panel of claim 1, wherein said substance comprises at least one of paint, stain, sealant or oil.

14. The masking panel of claim 1, wherein another adhesive layer is positioned on an opposing side of the one side of the protective material in sufficient quantity at an orientation to attach an extension protective material to said protective material.

15. The masking panel of claim 14, further comprising at least one removable strip covering said other adhesive.

16. The masking panel of claim 14, wherein said protective material is different form the extension protective material

17. The masking panel of claim 16, wherein said extension protective material comprise a non-rigid material.

18. A masking panel that masks a protected surface from a substance being applied to an unprotected surface adjacent to said protected surface, comprising:
a protective material having at least one masking edge having a masking edge shape corresponding to a masking boundary between said protected surface and said unprotected surface, said masking edge shape being pre-fabricated to substantially match said masking boundary, said protective material having sufficient rigidity to maintain said masking edge shape during installation of said masking panel along said masking boundary; and
an adhesive layer along said at least one masking edge that has a pressure applied along said masking boundary during installation of said masking panel, said pressure causing said installable masking panel to adhere to said protected surface so as to maintain said masking boundary during the application of said substance to said unprotected surface, said masking boundary substantially preventing said substance from being applied to said protected surface, said installable masking panel being installed along said masking boundary by holding said installable masking panel by a holding edge with a first hand while applying said pressure along said at least one masking edge with a second hand.
